(19) United States
(12) Patent Application Publication
(10) Pub. No.: US 2023/0415598 A1
(43) Pub. Date: Dec. 28, 2023

(54) MEANS OF TRANSPORTATION FOR ELECTRIC VEHICLES

(71) Applicant: AUDI AG, Ingolstadt (DE)

(72) Inventor: Frank Pfeffer, Kipfenberg (DE)

(21) Appl. No.: 18/338,943

(22) Filed: Jun. 21, 2023

(30) Foreign Application Priority Data
Jun. 27, 2022 (DE) 10 2022 115 891.8

(51) Int. Cl. B60L 53/52; B60L 53/51; H02J 7/35

(52) U.S. Cl. CPC B60L 53/52; B60L 53/51; H02J 7/35

(57) ABSTRACT

A transportation system for electric vehicles, such as battery electric vehicles (BEV) and plugin hybrid vehicles, as well as a method for the transporting of electric vehicles are provided.

### BACKGROUND

### Technical Field

The present disclosure relates to a means of transportation for electric vehicles, such as battery electric vehicles (BEV) and plugin hybrid vehicles, as well as a method for the transporting of electric vehicles.

### Description of the Related Art

For the transportation of battery-operated electric vehicles such as BEV and plugin hybrid vehicles from the manufacturer to the dealers and importers (via truck or freight train or by sea), the vehicle batteries are generally not fully charged and furthermore they become discharged during the transport. The vehicle batteries at the destination have a low state of charge and therefore the vehicles have only a slight range. Therefore, the energy accumulators of the electric vehicles must first be fully charged after arrival at the destination, before they can be used for normal driving operation. It would therefore be advantageous if the vehicles could be handed over already fully charged upon delivery (unloading of cargo).

The document EP 2 572 922 A1 relates to a method for charging an energy accumulator of an electric vehicle, during which the electric vehicle is located on part of a railway train, as well as an electrical power supply which can be installed on a railway train. On one part of a railway train there is provided an electrical power supply, which is suitable to providing electric energy to charge an energy accumulator of an electric vehicle while the electric vehicle is located on the railway train.

The document U.S. Pat. No. 10,940,873 B1 discloses a passenger and automobile delivery train with a plurality of railway cars, comprising a first level for the passenger transport; a second level for the transport of electric cars; an electrical power supply for charging the electric cars; an electrical circuit between the electrical power supply and the electric cars; an electrical plug and an electrical receptacle, which are provided at one end of the last railway car of the plurality of railway cars and are configured as parts of the electrical circuitry for the train; and an electrical cable, which connects one of the electrical plug and the electrical receptacle situated on one side of the last railway car to the other of the electrical plug and the electrical receptacle situated on the other side of the last railway car, in order to complete the electrical circuit.

From the document DE 10 2019 129 949 A1, there is known an automobile car suitable for rail transit, which can deliver at least one motor vehicle. The automobile car comprises a charging device, which supplies electric power to the motor vehicle being delivered in order to charge an electric energy accumulator of the motor vehicle. The charging device produces an electrical charging connection between the charging device and the motor vehicle and can be fed with an electrical output power across a supply line.

### BRIEF SUMMARY

Embodiments of the disclosure provide systems, devices and methods with which electric vehicles can be transported and their energy accumulators charged during transport.

Embodiments include a transportation system for a group of electric vehicles (such as BEV, plugin hybrid vehicles, etc.), comprising at least one wind energy plant, which is adapted to utilize the airflow during the movement of the transportation system to generate electricity and to store this in energy accumulators of electric vehicles being transported by the transportation system.

In one embodiment, the transportation system is a land vehicle. In another embodiment, the transportation system is railbound. In an alternative embodiment, the transportation system comprises a freight train. In another embodiment, the transportation system is a road vehicle. In an alternative embodiment, the transportation system comprises a truck.

In another embodiment, the transportation system is a water vehicle. In an alternative embodiment, the transportation system comprises a freighter.

According to embodiments of the invention, the transportation system comprises at least one wind energy plant, which is adapted to utilize the airflow during the movement of the transportation system to generate electricity and to store this in energy accumulators of electric vehicles being transported by the transportation system. In one embodiment, the at least one wind energy plant comprises at least one wind turbine, which is designed as a lift rotor having a horizontal axis. In an alternative embodiment, the at least one wind energy plant comprises at least one wind turbine, which is designed as a Darrieus rotor having a vertical axis.

In one embodiment, the transportation system additionally comprises at least one photovoltaic layout, which is adapted to feed the electricity generated into energy accumulators of electric vehicles being transported by the transportation system.

According to embodiments of the invention, the transportation system utilizes this energy by converting wind power (airflow) and optionally light energy (photovoltaics) into electricity in order to charge battery-operated vehicles (BEVs, plugin hybrid vehicles, etc.) during the transportation. A useful attribute here is that, for example, a moving train generates a virtual “wind” due to the air drag, or that winds prevail on the high seas, for example. In this way, electricity can be generated by placing at least one small wind turbine, optimally many small wind turbines, on a railway car or a truck trailer or aboard a freighter, and optionally also placing photovoltaic panels on suitable surfaces of the transportation system (ship, truck, train), with which the vehicles can be charged along the transportation route. In some embodiments, the transportation system may require a lengthy time, or they are used for the transportation with lengthy transport routes or times, so that the wind turbines need not be very large and therefore their power may be low. Neither embodiments would need the power of the solar panels to be very high.

In one embodiment, at least one small vertical wind turbine (Darrieus rotor) is used, and preferably many small vertical wind turbines are used. The use of horizontal wind turbines is also possible. The wind turbines may be used in a vertical as well as a horizontal layout. Additionally, the advantageous small design of the wind turbines should be pointed out. Wind turbines, such as are commonly found in wind parks in windy places, are not needed. Likewise, a tall mast is unnecessary and is even counterproductive (costs, stiffness/resonance ratio).

According to embodiments of the invention, the transportation system comprises components for energy production, namely, at least one wind energy plant and optionally at least one photovoltaic layout, components for converting the generated electricity into a form of electricity suitable for charging a vehicle energy accumulator of an electric vehicle via a charging interface of the electric vehicle, such as by an inverter or a DC/DC converter, and optionally at least one energy accumulator for buffered storage of excess electricity if the maximum capacity of the vehicle batteries is reached.

Embodiments also include a method for the transporting of electric vehicles in which energy accumulators of the electric vehicles are charged with electricity during the transporting of the electric vehicles by a transportation system, which is generated by at least one wind energy plant of the transportation system.

In one embodiment of the method, the airflow resulting from movement of the transportation system is utilized to generate electricity by at least one wind energy plant of the transportation system, which is converted into a suitable form for the charging of the energy accumulator of an electric vehicle via a charging interface of the electric vehicle and used for charging the energy accumulators of the transported electric vehicles.

An advantage of the wind energy plants is that they may convert energy even at night or under unfavorable lighting conditions. Thanks to the forward movement of the transportation system, such as a freight train moving at speeds of up to 120 km/h, this generates enough wind power to operate small wind turbines. Further advantages and embodiments of the disclosure will emerge from the description and the accompanying drawings.

The above mentioned features and those yet to be described herein can be used not only in the particular indicated combination, but also in other combinations or standing alone, without leaving the scope of the present disclosure.

### BRIEF DESCRIPTION OF THE SEVERAL VIEWS OF THE DRAWINGS

Embodiments are represented schematically with the aid of the drawings and shall be further described with reference to the drawings.

FIG. 1 shows a schematic representation of one embodiment of a transportation system.

FIG. 2 shows a schematic representation of an alternative embodiment of a transportation system.

### DETAILED DESCRIPTION

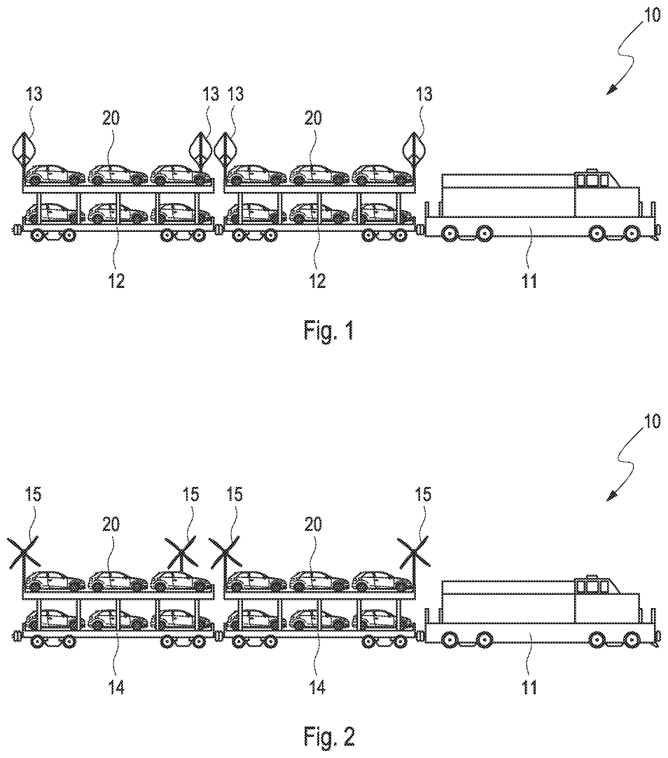

FIG. 1 shows a schematic representation of one embodiment of a transportation system 10 for BEVs 20. The transportation system 10 comprises a locomotive 11 and two transport cars 12 configured as double deck cars for a plurality of BEVs 20. Each transport car 12 comprises wind energy plants 13 having Darrieus rotors. The wind energy plants 13 generate electricity during the movement of the transportation system 10 from the airflow, which is taken to the BEVs 20 and charges their energy accumulators.

FIG. 2 shows a schematic representation of an alternative embodiment of a transportation system 10 for BEVs 20. The transportation system 10 comprises a locomotive 11 and two transport cars 14 configured as double deck cars for a plurality of BEVs 20. Each transport car 14 comprises wind energy plants 15 with wind turbines which are configured as lift rotors having a horizontal axis. The wind energy plants 15 generate electricity during the movement of the transportation system 10 from the airflow, which is taken to the BEVs 20 and charges their energy accumulators.

German patent application no. 10 2022 115891.8, filed Jun. 27, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A transportation system for a group of electric vehicles, comprising:
at least one wind energy plant, which is adapted to utilize the airflow during the movement of the transportation system to generate electricity and to store this in energy accumulators of electric vehicles being transported by the transportation system.

2. The transportation system according to claim 1, wherein the transportation system is a land vehicle.

3. The transportation system according to claim 2, wherein the land vehicle is a freight train.

4. The transportation system according to claim 2, wherein the land vehicle is a truck.

5. The transportation system according to claim 1, wherein the transportation system is a water vehicle.

6. The transportation system according to claim 5, wherein the water vehicle is a freighter.

7. The transportation system according to claim 1, wherein the at least one wind energy plant comprises at least one wind turbine.

8. The transportation system according to claim 7, wherein the at least one wind turbine is designed as a lift rotor with horizontal axis.

9. The transportation system according to claim 7, wherein the at least one wind turbine is designed as a Darrieus rotor with a vertical axis.

10. The transportation system according to claim 1, further comprising at least one photovoltaic layout.

11. A method for transporting of electric vehicles, comprising:
generating electricity by at least one wind energy plant of a transportation system; and
charging energy accumulators of the electric vehicles with the electricity generated during transport of the electric vehicles via the transportation system.
